(19) United States
(12) Patent Application Publication
(10) Pub. No.: US 2026/0338168 A1
(43) Pub. Date: Oct. 29, 2026

(54) METHOD AND SYSTEM FOR PROBABILISTIC PREDICTION OF MEDIUM AND LONG-TERM WIND POWER BASED ON TIME SEQUENCE ATTENTION

(71) Applicant: Guizhou Power Grid Co., Ltd., Guiyang (CN)

(72) Inventors: Bin WANG, Guiyang (CN); Julong CHEN, Guiyang (CN); Yu ZHANG, Guiyang (CN); Chen LUO, Guiyang (CN); Xuepeng MOU, Guiyang (CN); Wei WANG, Guiyang (CN); Rundong GAN, Guiyang (CN); Shiping YANG, Guiyang (CN); Ning LUO, Guiyang (CN); Chao LIN, Guiyang (CN); Yongqing ZHU, Guiyang (CN); Heng LIU, Guiyang (CN); Tianxuan ZHONG, Guiyang (CN); Wenxia LIU, Guiyang (CN); Kuanxiang ZHAO, Guiyang (CN)

(21) Appl. No.: 19/391,916

(22) Filed: Nov. 17, 2025

Related U.S. Application Data
(63) Continuation of application No. PCT/CN2025/129566, filed on Oct. 23, 2025.

(30) Foreign Application Priority Data
Apr. 25, 2025 (CN) 202510526072.8

(51) Int. Cl. F03D 17/00; G06N 7/01

(52) U.S. Cl. CPC F03D 17/026; G06N 7/01; F05B 2260/8211

(57) ABSTRACT

Provided are a method and a system for probabilistic prediction of medium and long-term wind power based on time sequence attention, relating to the technical field of wind power prediction. The method includes: preprocessing meteorological data and fan power data of a wind farm; in a Multi-attention Temporal Hybrid (MAHT) module, obtaining a dependency feature in a sequence by global attention, local attention, and a memory unit. The method fully uses different feature extraction modules to extract a sequence feature, and introduces probabilistic prediction and error correction.

### CROSS-REFERENCE TO RELATED APPLICATIONS

The present application is a continuation of International Application No. PCT/CN2025/129566, filed on Oct. 23, 2025, and claims priority to Chinese Patent Application No. 202510526072.8, filed on Apr. 25, 2025, the entire disclosure of which is incorporated herein by reference.

### TECHNICAL FIELD

The present disclosure relates to the technical field of wind power prediction, and in particular to a method and a system for probabilistic prediction of medium and long-term wind power based on time sequence attention.

### BACKGROUND

As a clean and renewable energy, a wind energy plays an increasingly important role in a global energy structure. However, due to instability and uncontrollability of the wind energy, fluctuation of wind power generation brings certain challenges to stable operation of a power grid and management of a power market. Therefore, accurate prediction of wind power has become one of key technologies to improve economy and reliability of a wind power system. Medium and long-term wind power prediction can arrange an operation plan, a maintenance plan, and a power trading strategy of the power grid in advance, which is of great significance to the safe operation and planning of the power system.

Methods for prediction of medium and long-term wind power can be mainly summarized as a physical method, a statistical method, and an artificial intelligence method. Based on a physical principle of meteorology and wind power generation, the physical method simulates and predicts wind power by constructing a complex mathematical model, which usually involves in-depth study of wind field characteristics, including an impact of factors such as topography, vegetation, and obstacles on a wind speed and a wind direction. Because the physical method depends on the accurate physical model and a lot of meteorological data, the physical method has a large amount of calculation and high complexity. The statistical method focuses on extracting a statistical relationship between wind power and a meteorological factor from historical data, and predicting wind power by constructing a time sequence model, a regression model or a machine learning algorithm based on a probability statistics theory. The statistical method does not need to know the physical characteristics of a wind farm deeply, but relies on regularity and correlation of historical data, and the prediction accuracy may be limited when dealing with a nonlinear, unstable, complex and changeable wind farm environment.

An artificial intelligence method, especially a machine learning and deep learning technique, has made remarkable progress in the field of wind power prediction in recent years. Deep learning can automatically learn a complex mapping relationship between wind power and various meteorological factors from a large number of historical data without explicitly constructing a physical model or a statistical model. The artificial intelligence method may capture temporal and spatial distribution features of wind power, periodic changes and impact of extreme weather events. Because the artificial intelligence method has powerful data processing capability and pattern identification capability, the artificial intelligence method can provide more accurate and stable prediction results, and perform well especially when dealing with nonlinear, unstable, complex and changeable wind farm data.

### SUMMARY

In view of the above existing problems, the present disclosure has been made.

Therefore, the present disclosure provides a method and a system for probabilistic prediction of medium and long-term wind power based on time sequence attention, which solve the problem of how to reduce dependency on a large number of accurate data and high-complexity calculation on the premise of ensuring prediction accuracy, and improve the wind power prediction capability in a nonlinear, unstable, complex and changeable environment at the same time.

In order to solve the above technical problems, the present disclosure provides the following technical solution.

In a first aspect, the present disclosure provides a method for probabilistic prediction of medium and long-term wind power based on time sequence attention, including:
obtaining and preprocessing meteorological data and fan power related data of a wind farm;
inputting the preprocessed data set into an encoder of a multi-attention dependency relationship calculation module and a time sequence feature extraction module, respectively, to obtain first feature data with local and long-term dependency and second feature data with time sequence information;
inputting the first feature data and the second feature data into a bidirectional cross-attention module, and fusing features extracted by different modules by calculating the attention weight;
performing probabilistic prediction of medium and long-term wind power based on the fused feature to obtain a preliminary prediction result; and
introducing an adaptive exponential smoothing error correction module to correct the preliminary prediction result to obtain a final result of probabilistic prediction of medium and long-term wind power.

As a preferred solution of the method for probabilistic prediction of medium and long-term wind power based on time sequence attention, the preprocessing process includes:
each xᵢ in a data set D={x₁, x₂, . . . , xₙ} being a d-dimensional feature vector, filling missing values of the meteorological data and the wind power by using a dynamic adaptive K-nearest neighbor filling method, and calculating a local density of the current missing points by calculating a Mahalanobis distance between a missing point and the nearest Kₘₐₓ neighbors in a training set;
dynamically selecting a value of K according to the local density;
calculating a Gaussian weight wᵢₗ of the missing point and each neighboring point, and adding a time sequence regularization term; and
after normalizing the calculated Gaussian weight, calculating the missing values and filling the missing values in corresponding positions, performing a normalizing process on the meteorological data and the wind power data which are filled with the missing values, and dividing the data set into a training set and a test set.

As a preferred solution of the method for probabilistic prediction of medium and long-term wind power based on time sequence attention, obtaining first feature data with local and long-term dependency includes:
dividing an original time sequence into a plurality of local windows, where each window contains n time steps, self-attention is calculated in each window, and local attention representations of all windows are spliced in chronological order to obtain local attention of the sequence;
using the original time sequence as an input of global attention, calculating self-attention on the whole sequence to obtain global attention;
introducing a memory unit, using an attention mechanism to use an input sequence as a query, using the memory unit as a key and a value, retrieving information most related to a current input from the memory unit by calculating an attention weight, and dynamically updating the memory unit through a gated structure according to the current input; and
fusing outputs of the local attention, the global attention and the memory unit by using a dynamic weight through a gated fusion mechanism, inputting the fused data into a feedforward neural network of a Transformer encoder, and outputting the fused data to obtain the first feature data with local and long-term dependency.

As a preferred solution of the method for probabilistic prediction of medium and long-term wind power based on time sequence attention, obtaining second feature data with time sequence information includes:
inputting the preprocessed data set into the time sequence feature extraction module, and inputting the preprocessed data set into a Relu activation function after being processed by a first convolutional layer and a second convolutional layer; and
performing channel matching on the number of input channels and the number of output channels through a downsampling operation, and performing residual connection with the input data to obtain the second feature data with time sequence information.

As a preferred solution of the method for probabilistic prediction of medium and long-term wind power based on time sequence attention, fusing features extracted by different modules by calculating the attention weight includes:
using the first feature data with local and long-term dependency as a query, using the second feature data with time sequence information as a key and a value, calculating the attention weight by using a multi-head attention mechanism, multiplying the attention weight by a value vector element, and performing weighted summing on a result;
using the second feature data with time sequence information as a query, using the first feature data with local and long-term dependency as a key and a value, calculating the attention weight by using the multi-head attention mechanism, multiplying the attention weight by the value vector element, and performing weighted summing on the result; and
splicing two pieces of data obtained by performing weighted summing in a feature dimension, mapping the spliced features to a target dimension by using a fully connected layer, and obtaining the fused feature data by residual connection.

As a preferred solution of the method for probabilistic prediction of medium and long-term wind power based on time sequence attention, performing probabilistic prediction of medium and long-term wind power based on the fused feature includes:
defining a loss function of a quantile and a quantile regression, where the loss function of the quantile regression is expressed as:

$${L}_{τ} ( y , \hat{y} ) = \{ \begin{matrix}τ \cdot ( y - \hat{y} ) & y \geq \hat{y} \\ ( 1 - τ ) \cdot ( \hat{y} - y ) & \hat{y} < y\end{matrix}$$

where τ denotes a target quantile, y denotes a true value, and ŷ denotes a predicted value;
constructing a quantile regression Long Short-Term Memory (LSTM) model, using the obtained data of fusing time sequence and dependency features as an input of the quantile regression LSTM model, and performing probabilistic prediction of future wind power, where a size of an output layer is equal to the number of quantiles; and
using the obtained predicted value of each quantile as a reference point of probability distribution, fitting normal probability distribution, and calculating a coverage probability to evaluate accuracy of a probability prediction interval, where the formula is as follows:

$$C P = \frac{1}{N} {\sum }_{i = 1}^{N} Π ( {y}_{i} ∈ [ L , U ] )$$

where CP denotes a coverage probability, N denotes a sample space, yᵢ denotes a true value of an i-th sample, Π(·) indicates that the value is 1 if a function condition holds, otherwise, the value is 0, L denotes a lower limit of a prediction interval, and U denotes an upper limit of the prediction interval.

As a preferred solution of the method for probabilistic prediction of medium and long-term wind power based on time sequence attention, introducing an adaptive exponential smoothing error correction module to correct the preliminary prediction result to obtain a final result of probabilistic prediction of medium and long-term wind power includes:
calculating an error sequence and defining a dynamic adjustment factor;
dynamically adjusting the smoothing coefficient according to the change of the error sequence; and
calculating an improved exponential smoothing formula according to the dynamic adjustment factor, inputting a smoothed error sequence into a model to obtain a corrected error sequence, and adding the corrected error sequence with a prediction sequence to obtain the final result of probabilistic prediction of medium and long-term wind power.

In a second aspect, the present disclosure provides a system for probabilistic prediction of medium and long-term wind power based on time sequence attention, including:
a data acquisition and processing unit, which is configured to obtain and preprocess meteorological data and fan power related data of a wind farm;
a sequence feature extraction unit, which is configured to input the preprocessed data set into an encoder of a multi-attention dependency relationship calculation module and a time sequence feature extraction module, respectively, to obtain first feature data with local and long-term dependency and second feature data with time sequence information;
a feature fusion unit, which is configured to input the first feature data and the second feature data into a bidirectional cross-attention module, and fuse features extracted by different modules by calculating the attention weight;
a probabilistic prediction unit, which is configured to perform probabilistic prediction of medium and long-term wind power based on the fused feature to obtain a preliminary prediction result; and
a prediction result correction unit, which is configured to introduce an adaptive exponential smoothing error correction module to correct the preliminary prediction result to obtain a final result of probabilistic prediction of medium and long-term wind power.

In a third aspect, the present disclosure provides an electronic device, including:
a memory and a processor;
where the memory is configured to store computer-executable instructions, the processor is configured to execute the computer-executable instructions, and the computer-executable instructions, when executed by the processor, implement the steps of the method for probabilistic prediction of medium and long-term wind power based on time sequence attention.

In a fourth aspect, the present disclosure provides a computer-readable storage medium having computer-executable instructions stored thereon, where the computer-executable instructions, when executed by a processor, implement the steps of the method for probabilistic prediction of medium and long-term wind power based on time sequence attention.

Compared with the prior art, the present disclosure has the following beneficial effects. The present disclosure provides a method and a system for probabilistic prediction of medium and long-term wind power based on time sequence attention. The modeling capability of dependency relationships at different time scales in the time sequence is significantly improved through a layered design in which short-term dependency is captured by local attention and long-term dependency is captured by global attention. The memory unit is introduced to explicitly store historical key information. The capturing capability of key historical patterns in a super-long sequence is enhanced through a dynamic retrieval and updating mechanism. Moreover, the present disclosure can effectively capture nonlinear and complex patterns in wind power data, dynamically adjust the prediction result according to the real-time data, adapt to the rapid change of wind power, and provide probability distribution prediction of wind power at the same time, which is not just single-point prediction. The probabilistic prediction can help a wind farm operator better evaluate a future power fluctuation range, thereby improving reliability of power grid dispatching. In addition, the dynamic adjustment factor is introduced, so that the present disclosure can dynamically adjust the smoothing coefficient according to the change of the error sequence, have strong adaptability to the change of the error sequence, and maintain a good smoothing effect under different error distribution conditions, thereby improving prediction accuracy.

### BRIEF DESCRIPTION OF THE DRAWINGS

In order to explain the technical solution of the embodiment of the present disclosure more clearly, the accompanying drawings needed in the description of the embodiment will be briefly introduced below. Obviously, the accompanying drawings in the following description are only some embodiments of the present disclosure. For those skilled in the art, other accompanying drawings can be obtained according to these accompanying drawings without paying creative labor.

FIG. 1 is a schematic diagram of an overall process logic of a method according to an embodiment of the present disclosure;

FIG. 2 is a structure diagram of a module process of a method according to an embodiment of the present disclosure;

FIG. 3 is a graph of a prediction result of a method according to an embodiment of the present disclosure;

FIG. 4 is a schematic diagram of a comparative experiment of a method according to an embodiment of the present disclosure; and

FIG. 5 is a schematic diagram of a comparison curve of a mean square error of a method according to an embodiment of the present disclosure.

### DETAILED DESCRIPTION OF THE EMBODIMENTS

In order to make the above objectives, features and advantages of the present disclosure more obvious and understandable, the specific embodiments of the present disclosure will be described in detail with reference to the accompanying drawings in the specification. Obviously, the described embodiments are some embodiments of the present disclosure, rather than all of the embodiments. Based on the embodiments in the present disclosure, all other embodiments obtained by those skilled in the art without paying creative labor should belong to the scope of protection of the present disclosure.

### Embodiment 1

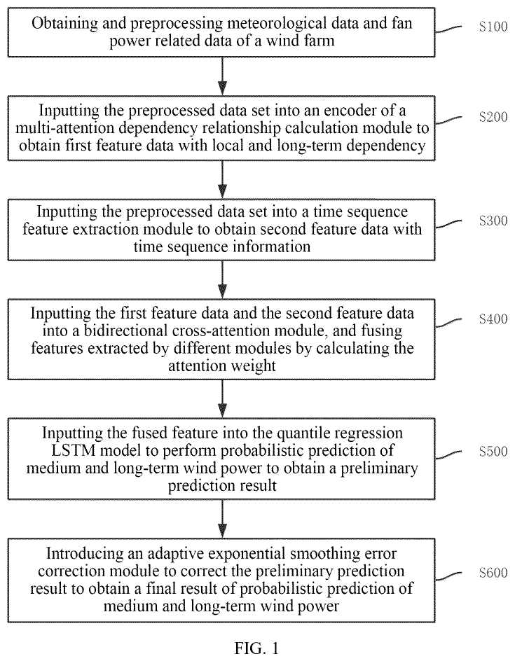

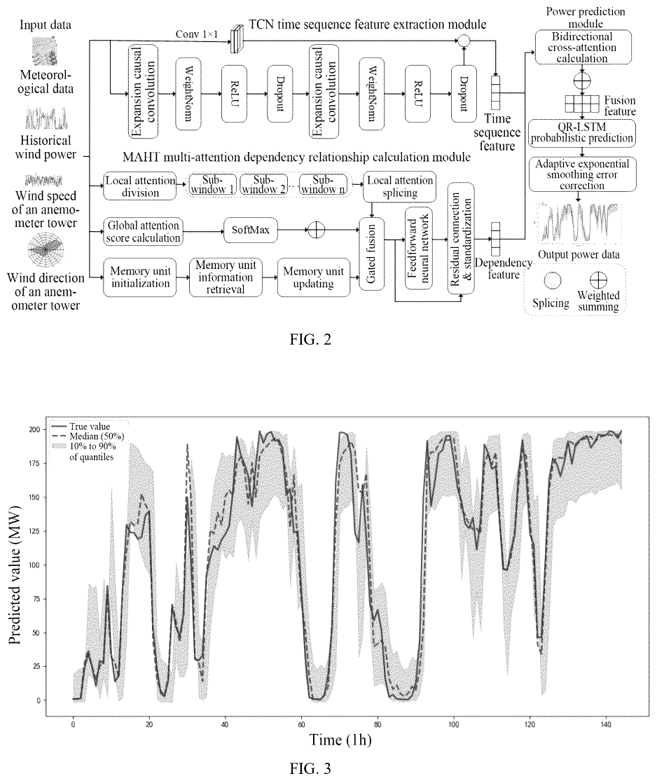

With reference to FIG. 1 and FIG. 2, according to an embodiment of the present disclosure, a method for probabilistic prediction of medium and long-term wind power based on time sequence attention is provided, which specifically includes the following steps as shown in FIG. 1:
S100: obtaining and preprocessing meteorological data and fan power related data of a wind farm;
S200: inputting the preprocessed data set into an encoder of a multi-attention dependency relationship calculation module to obtain first feature data with local and long-term dependency;
S300: inputting the preprocessed data set into a time sequence feature extraction module to obtain second feature data with time sequence information;
S400: inputting the first feature data and the second feature data into a bidirectional cross-attention module, and fusing features extracted by different modules by calculating the attention weight;
S500: inputting the fused feature into the quantile regression LSTM model to perform probabilistic prediction of medium and long-term wind power to obtain a preliminary prediction result; and
S600: introducing an adaptive exponential smoothing error correction module to correct the preliminary prediction result to obtain a final result of probabilistic prediction of medium and long-term wind power.

It should be noted that the present disclosure provides a method and a system for probabilistic prediction of medium and long-term wind power based on time sequence attention. The modeling capability of dependency relationships at different time scales in the time sequence is significantly improved through a layered design in which short-term dependency is captured by local attention and long-term dependency is captured by global attention. The memory unit is introduced to explicitly store historical key information. The capturing capability of key historical patterns in a super-long sequence is enhanced through a dynamic retrieval and updating mechanism. Moreover, the present disclosure can effectively capture nonlinear and complex patterns in wind power data, dynamically adjust the prediction result according to the real-time data, adapt to the rapid change of wind power, and provide probability distribution prediction of wind power at the same time, which is not just single-point prediction. The probabilistic prediction can help a wind farm operator better evaluate a future power fluctuation range, thereby improving reliability of power grid dispatching. In addition, the dynamic adjustment factor is introduced, so that the present disclosure can dynamically adjust the smoothing coefficient according to the change of the error sequence, have strong adaptability to the change of the error sequence, and maintain a good smoothing effect under different error distribution conditions, thereby improving prediction accuracy.

FIG. 2 shows a diagram of an overall structure of a method for probabilistic prediction of medium and long-term wind power based on time sequence attention. The method for probabilistic prediction of medium and long-term wind power according to the present disclosure will be described in detail based on FIG. 2.

In the embodiment of the present disclosure, the above step S100 includes the following sub-steps A1 to A2.

In A1, the historical wind power data, the wind speed at an anemometer tower, the wind direction at an anemometer tower, and ERA5 meteorological data are obtained.

In A2, the obtained data is preprocessed, mainly including dynamically filling the missing data.

Specifically, the preprocessing process includes:
each xᵢ in a data set D={x₁, x₂, . . . , xₙ} being a d-dimensional feature vector, filling missing values of the meteorological data and the wind power by using a dynamic adaptive K-nearest neighbor filling method, and calculating a local density of the current missing points by calculating a Mahalanobis distance between a missing point and the nearest Kₘₐₓ neighbors in a training set. The Mahalanobis distance and the local density of the missing points are calculated as follows:

$$dist ( {x}_{i} , {x}_{l} ) = \sqrt{{( {x}_{i} - {x}_{l} )}^{T} {\sum }^{- 1} ( {x}_{i} - {x}_{l} )}$$

$${ρ}_{i} = \frac{1}{{\sum }_{l = 1}^{{K}_{max}} dist ( ; {x}_{i} , {x}_{l} )}$$

where dist(xᵢ,xₗ) denotes the Mahalanobis distance between the missing point xᵢ and the nearest neighbor point xₗ, Σ⁻¹ denotes the inverse of a covariance matrix, and Kₘₐₓ denotes the preset maximum number of the nearest neighbors.

A value of K is dynamically selected according to the local density. The higher the local density, the greater the value of K, and the lower the local density, the smaller the value of K, as shown in the following formula:

$${K}_{i} = {K}_{min} + ( {K}_{max} - {K}_{min} ) \times ( 1 - \frac{{ρ}_{i}}{{ρ}_{max}} )$$

where Kₘᵢₙ and Kₘₐₓ denote preset minimum and maximum values, which determine the range of the dynamic value of K; and ρₘₐₓ denotes a maximum value of the local density of all missing points.

On the premise of determining the value of K, a Gaussian weight wᵢₗ of the missing point and each neighboring point is calculated, and a time sequence regularization term is added to avoid over-fitting. The time sequence regularization term and the Gaussian weight are as follows:

$$R ( {x}_{l} ) = exp ( - \frac{{( {t}_{i} - {t}_{l} )}^{2}}{2 {τ}^{2}} )$$

$${w}_{i l} = exp ( - \frac{{dist ( {x}_{i} , {x}_{l} )}^{2}}{2 {σ}^{2}} ) + λ \times R ( {x}_{l} )$$

where R(xₗ) denotes the time sequence regularization term, tᵢ denotes the timestamp of the missing point xᵢ, tₗ denotes the timestamp of the neighboring point x₁, τ denotes a time scale parameter, σ denotes a standard deviation of the Gaussian weight, and λ denotes a regularization coefficient.

After normalizing the calculated Gaussian weight, the missing values are calculated and filled in corresponding positions.

A normalizing process is performed on the meteorological data and the wind power data which are filled with the missing values, and the data set is divided into a training set and a test set.

It should be noted that in the above step S100 of obtaining and preprocessing meteorological data and fan power related data of a wind farm, high-quality and structured input data is provided for subsequent analysis, so as to ensure accuracy and availability of the data.

In the embodiment of the present disclosure, the above step S200 includes the following sub-steps B1 to B4.

In B1, an original time sequence is divided into a plurality of local windows. Each window contains n time steps. Self-attention is calculated in each window, and local attention representations of all windows are spliced in chronological order to obtain local attention of the sequence. The data dimension is 32×16×32.

In B2, using the original time sequence as an input of global attention, self-attention is calculated on the whole sequence to obtain global attention. The dimension of the input feature is 7, the number of attention heads is 2, and the dimension of global attention representations is 32×16×32.

In B3, a memory unit is introduced. An attention mechanism is used to use an input sequence as a query. The memory unit is used as a key and a value. Information most related to a current input is retrieved from the memory unit by calculating an attention weight. The memory unit is dynamically updated through a gated structure according to the current input. The memory unit is a learnable parameter matrix with the size of 64, which is configured to store historical information.

In B4, outputs of the local attention, the global attention and the memory unit are fused by using a dynamic weight through a gated fusion mechanism. The fused data is input into a feedforward neural network of a Transformer encoder, and the fused data is output to obtain the first feature data with local and long-term dependency. The data dimension is 32×16×32.

It should be noted that in the above step S200 of inputting the preprocessed data set into an encoder of a multi-attention dependency relationship calculation module to extract first feature data with local and long-term dependency, the short-term fluctuations and the long-term trends in the data are effectively captured, the modeling capability of the model for dependency relationships at different time scales is enhanced, and accuracy and reliability of prediction are improved.

In the embodiment of the present disclosure, the above step S300 includes the following sub-steps C1 to C3.

In C1, the preprocessed data set passes through a first convolutional layer of the time sequence feature extraction module, where the convolution kernel has a size of 3 and an expansion coefficient of 1. After cropping and filling operations, the redundant filling part is removed, and the weight is standardized. The preprocessed data set is input into a Relu activation function.

It should be noted that in order to ensure that the model can only rely on current and past information, the right side of the input sequence is filled with zero values in the operation of the first convolutional layer, and the filling size is 2. After the convolution operation is completed, due to the presence of filling on the right side, the output time step may be a little more than the input time step. A cropping operation is required, and the cropping size is equal to the filling size in the convolution operation. The redundant filling part is removed by keeping all batches and channels, but cropping the last two elements in the time dimension.

In C2, the data obtained by passing through the first convolutional layer passes through a second convolutional layer of the time sequence feature extraction module, where the convolution kernel has a size of 3 and an expansion coefficient of 2. After cropping and filling operations, the redundant filling part is removed, and the weight is standardized. The data is input into a Relu activation function.

It should be noted that in order to ensure that the model can only rely on current and past information, the right side of the input sequence is filled with zero values in the operation of the second convolutional layer, and the filling size is 4. After the convolution operation is completed, due to the presence of filling on the right side, the output time step may be a little more than the input time step. A cropping operation is required, and the cropping size is equal to the filling size in the convolution operation. The redundant filling part is removed by keeping all batches and channels, but cropping the last four elements in the time dimension.

In C3, the number of input channels is consistent with the number of output channels through a downsampling operation. 1×1 convolution is used to perform channel matching. Finally, residual connection is performed with the input data to obtain the second feature data with time sequence information, where the data dimension is 32×16×64.

It should be noted that if the number of channels of output data of the second convolutional layer of the time sequence feature extraction module is inconsistent with the number of original data channels when the first convolutional layer of the time sequence feature extraction module is input, channel matching is performed on the original input data by using 1×1 convolution. If the number of channels of output data is consistent with the number of original data channels, no matching operation is required. Residual connection is performed between the output data of the second convolutional layer of the time sequence feature extraction module and the original input data or the original input data processed by channel matching to obtain the second feature data with time sequence information.

It should be noted that in the above step S300 of inputting the preprocessed data set into a time sequence feature extraction module to obtain second feature data with time sequence information, the time dynamic characteristics in the wind power data can be effectively captured, thereby providing rich time sequence information support for the subsequent fusion of different features, and enhancing the understanding and prediction capability of the model for the time sequence dependency relationship.

In the embodiment of the present disclosure, the above step S400 includes the following sub-steps D1 to D3.

In D1, the first feature data with local and long-term dependency is used as a query, the second feature data with time sequence information is used as a key and a value, the attention weight is calculated by using a multi-head attention mechanism, the attention weight is multiplied by a value vector element, and weighted summing is performed on a result.

In D2, the second feature data with time sequence information is used as a query, the first feature data with local and long-term dependency is used as a key and a value, the attention weight is calculated by using the multi-head attention mechanism, the attention weight is multiplied by the value vector element, and weighted summing is performed on the result.

In D3, two pieces of data obtained by performing weighted summing are spliced in a feature dimension, the spliced features are mapped to a target dimension by using a fully connected layer, and the fused feature data is obtained by residual connection. The dimension of the fused feature data is 32×16×32.

It should be noted that in the above step S400 of fusing the first feature data and the second feature data by using a bidirectional cross-attention module, the local and long-term dependency and the time sequence information are integrated in a manner of calculating the attention weight, so as to accurately capture the correlation between features extracted by different modules, improve the identification capability and prediction accuracy of the model for complex patterns, and allow the wind power prediction to be more accurate and reliable.

In the embodiment of the present disclosure, the above step S500 includes the following sub-steps E1 to E3.

In E1, a loss function of a quantile and a quantile regression is defined, where the quantile includes 0.1, 0.5, and 0.9, and the loss function of the quantile regression is expressed as:

$${L}_{τ} ( y , \hat{y} ) = \{ \begin{matrix}τ \cdot ( y - \hat{y} ) & y \geq \hat{y} \\ ( 1 - τ ) \cdot ( \hat{y} - y ) & \hat{y} < y\end{matrix}$$

where τ denotes a target quantile, y denotes a true value, and ŷ denotes a predicted value.

In E2, a quantile regression Long Short-Term Memory (LSTM) model is constructed, the obtained data of fusing time sequence and dependency features is used as an input of the quantile regression LSTM model, and probabilistic prediction of future wind power is performed.

Specifically, constructing a quantile regression LSTM model includes: using the LSTM as a core module, and adding a fully connected layer after the LSTM layer, where a size of an output layer is equal to the number of quantiles to generate the predicted value corresponding to each quantile.

In E3, the obtained predicted value of each quantile is used as a reference point of probability distribution, normal probability distribution is fit, and a coverage probability is calculated to evaluate accuracy of a probability prediction interval, where the formula is as follows:

$$CP = \frac{1}{N} {\sum }_{i = 1}^{N} Π ( {y}_{i} ∈ [ L , U ] )$$

where CP denotes a coverage probability, N denotes a sample space, yᵢ denotes a true value of an i-th sample, Π(·) indicates that the value is 1 if a function condition holds, otherwise, the value is 0, L denotes a lower limit of a prediction interval, and U denotes an upper limit of the prediction interval.

It should be noted that in the above step S500 of inputting the fused feature into the quantile regression LSTM model to perform probabilistic prediction of medium and long-term wind power, this can not only provide the probability distribution of wind power instead of a single predicted value, and effectively capture the nonlinear and complex patterns in wind power data, but also can dynamically adjust the prediction result according to real-time data to adapt to the rapid change of wind power, thereby improving accuracy and reliability of prediction and helping operators better evaluate the future power fluctuation range.

In the embodiment of the present disclosure, the above step S600 includes the following sub-steps F1 to F2.

In F1, an error sequence is calculated and a dynamic adjustment factor is defined, and a smoothing coefficient is dynamically adjusted according to a change of the error sequence, where the error sequence and the dynamic adjustment factor are as follows:

$${E}_{t} = {wpdata}_{t} - {pd}_{t}$$

$${β}_{t} = \frac{1}{1 + {e}^{- γ ( {E}_{t} - {E}_{t - 1} )}}$$

where βₜ denotes a dynamic adjustment factor, wpdataₜ and pdₜ denote a true value of wind power and an initial prediction result of a model at time t, Eₜ denotes an error sequence, and γ denotes an adjustment parameter to control sensitivity of dynamic adjustment.

In F2, an improved exponential smoothing formula is calculated according to the dynamic adjustment factor, a smoothed error sequence is input into a model to obtain a corrected error sequence, and the corrected error sequence is added with a prediction sequence to obtain the final result of probabilistic prediction of medium and long-term wind power, where the smoothed error sequence and the corrected error sequence are as follows:

$${E}_{t}^{s} = ( α + {β}_{t} ) {E}_{t} + ( 1 - α - {β}_{t} ) {E}_{t - 1}^{s}$$

$${E}_{t}^{c} = LSTM ( {E}_{t}^{s} )$$

where

$${E}_{t}^{s}$$

denotes a smoothed error sequence, α denotes a smoothing coefficient within a range of [0,1], and

$${E}_{t}^{c}$$

denotes a corrected error sequence.

It should be noted that in the above step S600 of introducing an adaptive exponential smoothing error correction module to correct the preliminary prediction result, the smoothing coefficient is automatically adjusted according to the change of the error sequence through dynamic adjustment factors, thereby effectively improving accuracy and adaptability of the prediction result, maintaining a good smoothing effect under different error distribution conditions, further reducing the prediction error, and ensuring stability and reliability of a final result of probabilistic prediction of wind power.

### Embodiment 2

With reference to FIG. 3 to FIG. 5, based on the previous embodiment, the embodiment provides an application example of the method for probabilistic prediction of medium and long-term wind power based on time sequence attention, in order to verify the technical effect used in this method.

The experimental data of the embodiment uses the recorded data of a domestic wind farm for two months. The data includes fan data and historical meteorological data including a wind speed, a wind direction, a temperature and an air pressure, in which the wind power data is sampled once every hour, the data of the first 50 days is used as training data, and the data of the last 10 days is used as test data. Table 1 shows quantitative analysis results of four wind power prediction methods. Each model is experimented on the test set divided by the present disclosure. R², a Root Mean Squared Error (RMSE), a Mean Squared Error (MSE), and a Mean Absolute Error (MAE) all take the average of 20 experiments.

TABLE 1
Quantitative Analysis Results of Four
Wind Power Prediction Methods

| Model | R² | RMSE | MSE | MAE |
|---|---|---|---|---|
| Bidirectional Gated | 0.73 | 0.075 | 0.062 | 0.063 |
| Recurrent Unit (BiGRU) | | | | |
| ConvLSTM | 0.75 | 0.058 | 0.046 | 0.051 |
| Temporal | 0.79 | 0.053 | 0.035 | 0.049 |
| Convolutional Network | | | | |
| (TCN)-Transformer | | | | |
| Quantile Regression | 0.81 | 0.043 | 0.029 | 0.032 |
| Long Short-Term | | | | |
| Memory (QR-LSTM) | | | | |
| (Method according to | | | | |
| the present disclosure) | | | | |

As can be seen from Table 1, the performance of the QR-LSTM is superior to other methods. The MSE of the QR-LSTM is up to 0.029, which is 0.006 lower than the TCN-Transformer, 0.017 lower than the ConvLSTM, and 0.033 lower than the BiGRU. In terms of R², the QR-LSTM is still the optimal, and the TCN-Transformer is close to the QR-LSTM, both of which are higher than the ConvLSTM and the BiGRU. Meanwhile, in terms of the RMSE and the MAE, the method according to the present disclosure is the optimal, and the performance is the most stable.

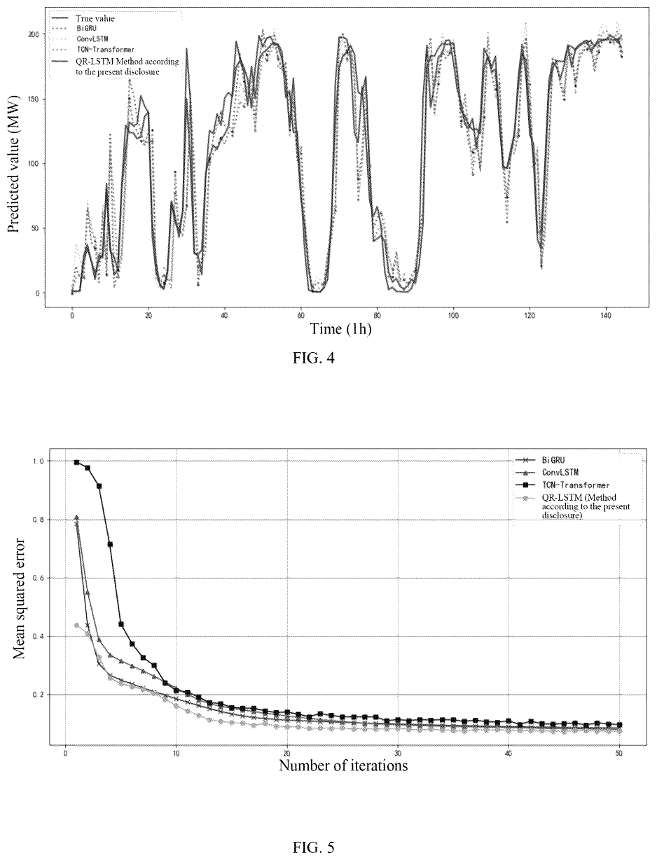

In addition, FIG. 3 shows results of probabilistic prediction of wind power for the next six days according to the present disclosure. It can be seen that the prediction result is close to the true value. FIG. 4 shows a comparative prediction experiment between the method according to the present disclosure and other methods, from which it can be seen that the prediction result of the method according to the present disclosure is more accurate. FIG. 5 shows comparison between mean square errors of the method according to the present disclosure and other methods, from which it can be seen that the method according to the present disclosure can achieve the lowest mean square error quickly.

From the foregoing embodiments, it can be seen that the present disclosure provides a method and a system for probabilistic prediction of medium and long-term wind power based on time sequence attention. The modeling capability of dependency relationships at different time scales in the time sequence is significantly improved through a layered design in which short-term dependency is captured by local attention and long-term dependency is captured by global attention. The memory unit is introduced to explicitly store historical key information. The capturing capability of key historical patterns in a super-long sequence is enhanced through a dynamic retrieval and updating mechanism. Moreover, the present disclosure can effectively capture nonlinear and complex patterns in wind power data, dynamically adjust the prediction result according to the real-time data, adapt to the rapid change of wind power, and provide probability distribution prediction of wind power at the same time, which is not just single-point prediction. The probabilistic prediction can help a wind farm operator better evaluate a future power fluctuation range, thereby improving reliability of power grid dispatching. In addition, the dynamic adjustment factor is introduced, so that the present disclosure can dynamically adjust the smoothing coefficient according to the change of the error sequence, have strong adaptability to the change of the error sequence, and maintain a good smoothing effect under different error distribution conditions, thereby improving prediction accuracy.

### Embodiment 3

In the embodiment, a system for probabilistic prediction of medium and long-term wind power based on time sequence attention is provided, including:
a data acquisition and processing unit, which is configured to obtain and preprocess meteorological data and fan power related data of a wind farm;
a sequence feature extraction unit, which is configured to input the preprocessed data set into an encoder of a multi-attention dependency relationship calculation module and a time sequence feature extraction module, respectively, to obtain first feature data with local and long-term dependency and second feature data with time sequence information;
a feature fusion unit, which is configured to input the first feature data and the second feature data into a bidirectional cross-attention module, and fuse features extracted by different modules by calculating the attention weight;
a probabilistic prediction unit, which is configured to perform probabilistic prediction of medium and long-term wind power based on the fused feature to obtain a preliminary prediction result; and
a prediction result correction unit, which is configured to introduce an adaptive exponential smoothing error correction module to correct the preliminary prediction result to obtain a final result of probabilistic prediction of medium and long-term wind power.

It should be noted that the technical solution of the system for probabilistic prediction of medium and long-term wind power based on time sequence attention belongs to the same concept as the technical solution of the foregoing method for probabilistic prediction of medium and long-term wind power based on time sequence attention. For details not described in detail in the technical solution of the system for probabilistic prediction of medium and long-term wind power based on time sequence attention in the embodiment, refer to the description of the technical solution of the foregoing method for probabilistic prediction of medium and long-term wind power based on time sequence attention.

The foregoing unit modules can be embedded in or independent of the processor in the computer device in the form of hardware, and can also be stored in the memory in the computer device in the form of software, so as to facilitate the processor to call and execute the operations corresponding to the foregoing modules.

This embodiment further provides an electronic device, which includes a processor, a memory, a communication interface, a display screen, and an input device which are connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for the operation of the operating system and computer programs in the non-volatile storage medium. A communication interface of the computer device is used for wired or wireless communication with an external terminal, and the wireless mode can be achieved by WIFI, an operator network, an NFC (Near Field Communication) or other technologies. The computer program, when executed by a processor, implements the method for probabilistic prediction of medium and long-term wind power based on time sequence attention. The display screen of the computer device can be a liquid crystal display screen or an electronic ink display screen. The input device of the computer device can be a touch layer covered on the display screen, or a button, a trackball or a touchpad arranged on a shell of the computer device, or an external keyboard, a touchpad or a mouse.

This embodiment further provides a computer-readable storage medium having a computer program stored thereon. The program, when executed by a processor, implements the method proposed in the foregoing embodiment.

The storage medium proposed in this embodiment belongs to the same inventive concept as the method proposed in the foregoing embodiment. For technical details not described in detail in the embodiment, refer to the foregoing embodiment. Moreover, this embodiment has the same beneficial effects as the foregoing embodiment.

From the above description of the embodiments, those skilled in the art can clearly understand that the present disclosure can be achieved by software and necessary general hardware, and of course, can also be achieved by hardware, but in many cases, the former is a better embodiment. Based on this understanding, the technical solution of the present disclosure, in essence, or the part that contributes to the prior art, can be embodied in the form of a software product. The computer software product can be stored in a computer-readable storage medium, such as a computer floppy disk, a Read-Only Memory (ROM), a Random Access Memory (RAM), a flash memory (FLASH), a hard disk or an optical disk, and the like, including several instructions to allow a computer device (which can be a personal computer, a server, or a network device, and the like) to execute the method of the embodiment of the present disclosure.

It should be noted that the foregoing embodiments are only used to illustrate the technical solution of the present disclosure, rather than limit the present disclosure. Although the present disclosure has been described in detail with reference to the preferred embodiments, those skilled in the art should understand that the technical solution of the present disclosure can be modified or replaced by equivalents without departing from the spirit and scope of the technical solution, which should be included in the scope of the claims of the present disclosure.

It should be understood by those skilled in the art that the embodiments of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure can take the form of a computer program product implemented on one or more computer-usable storage media (including but not limited to a magnetic disk storage, a Compact Disc Read-Only Memory (CD-ROM), an optical storage, and the like) containing computer-usable program codes. The solution in the embodiment of the present disclosure can be achieved by various computer languages.

The present disclosure is described with reference to a flow chart and/or a block diagram of a method, a device (a system), and a computer program product according to the embodiment of the present disclosure. It should be understood that each flow and/or block in the flow chart and/or block diagram, and combinations of the flow and/or block in the flow chart and/or the block diagram can be implemented by computer program instructions. These computer program instructions may be provided to a processor of a general-purpose computer, a special-purpose computer, an embedded processor or other programmable data processing devices to produce a machine, so that the instructions which are executed by the processor of the computer or other programmable data processing devices produce an apparatus for achieving the functions specified in one or more flows in the flow chart or one or more blocks in the block diagram.

These computer program instructions may also be stored in a computer-readable memory that can direct a computer or other programmable data processing devices to operate in a particular manner, so that the instructions stored in the computer-readable memory produce an article of manufacture including an instruction apparatus. The instruction apparatus achieves the functions specified in one or more flows in the flow chart or one or more blocks in the block diagram.

These computer program instructions may also be loaded onto a computer or other programmable data processing devices, so that a series of operation steps are performed on the computer or other programmable devices to produce a computer-implemented process, so that the instructions executed on the computer or other programmable devices provide steps for achieving the functions specified in one or more flows in the flow chart or one or more blocks in the block diagram.

Although the preferred embodiments of the present disclosure have been described, those skilled in the art can make additional changes and modifications to these embodiments once they know the basic inventive concepts. Therefore, the appended claims are intended to be interpreted as including the preferred embodiment and all changes and modifications that fall within the scope of the present disclosure.

Obviously, various modifications and variations can be made to the present disclosure by those skilled in the art without departing from the spirit and scope of the present disclosure. Thus, if these modifications and variations of the present disclosure fall within the scope of the claims of the present disclosure and their technical equivalents, the present disclosure is also intended to include these modifications and variations.

What is claimed is:

1. A method for probabilistic prediction of medium and long-term wind power based on time sequence attention, comprising:
obtaining and preprocessing meteorological data and fan power related data of a wind farm;
inputting the preprocessed data set into an encoder of a multi-attention dependency relationship calculation module and a time sequence feature extraction module, respectively, to obtain first feature data with local and long-term dependency and second feature data with time sequence information;
wherein obtaining first feature data with local and long-term dependency comprises:
dividing an original time sequence into a plurality of local windows, wherein each window contains n time steps, self-attention is calculated in each window, and local attention representations of all windows are spliced in chronological order to obtain local attention of the sequence;
using the original time sequence as an input of global attention, calculating self-attention on the whole sequence to obtain global attention;
introducing a memory unit, using an attention mechanism to use an input sequence as a query, using the memory unit as a key and a value, retrieving information most related to a current input from the memory unit by calculating an attention weight, and dynamically updating the memory unit through a gated structure according to the current input; and
fusing outputs of the local attention, the global attention and the memory unit by using a dynamic weight through a gated fusion mechanism, inputting the fused data into a feedforward neural network of a Transformer encoder, and outputting the fused data to obtain the first feature data with local and long-term dependency;
wherein obtaining second feature data with time sequence information comprises:
inputting the preprocessed data set into the time sequence feature extraction module, and inputting the preprocessed data set into a Relu activation function after being processed by a first convolutional layer and a second convolutional layer; and
performing channel matching on the number of input channels and the number of output channels through a downsampling operation, and performing residual connection with the input data to obtain the second feature data with time sequence information;
inputting the first feature data and the second feature data into a bidirectional cross-attention module, and fusing features extracted by different modules by calculating the attention weight;
wherein fusing features extracted by different modules by calculating the attention weight comprises:
using the first feature data with local and long-term dependency as a query, using the second feature data with time sequence information as a key and a value, calculating the attention weight by using a multi-head attention mechanism, multiplying the attention weight by a value vector element, and performing weighted summing on a result;
using the second feature data with time sequence information as a query, using the first feature data with local and long-term dependency as a key and a value, calculating the attention weight by using the multi-head attention mechanism, multiplying the attention weight by the value vector element, and performing weighted summing on the result; and
splicing two pieces of data obtained by performing weighted summing in a feature dimension, mapping the spliced features to a target dimension by using a fully connected layer, and obtaining the fused feature data by residual connection;
performing probabilistic prediction of medium and long-term wind power based on the fused feature to obtain a preliminary prediction result; and
introducing an adaptive exponential smoothing error correction module to correct the preliminary prediction result to obtain a final result of probabilistic prediction of medium and long-term wind power;
wherein introducing an adaptive exponential smoothing error correction module to correct the preliminary prediction result to obtain a final result of probabilistic prediction of medium and long-term wind power comprises:
calculating an error sequence and defining a dynamic adjustment factor, and dynamically adjusting a smoothing coefficient according to a change of the error sequence, wherein the error sequence and the dynamic adjustment factor are as follows:
$${E}_{t} = {wpdata}_{t} - {pd}_{t}$$
$${β}_{t} = \frac{1}{1 + {e}^{- γ ( {E}_{t} - {E}_{t - 1} )}}$$
where βₜ denotes a dynamic adjustment factor, wpdataₜ and pdₜ denote a true value of wind power and an initial prediction result of a model at time t, Eₜ denotes an error sequence, and γ denotes an adjustment parameter to control sensitivity of dynamic adjustment;
dynamically adjusting the smoothing coefficient according to the change of the error sequence; and
calculating an improved exponential smoothing formula according to the dynamic adjustment factor, inputting a smoothed error sequence into a model to obtain a corrected error sequence, and adding the corrected error sequence with a prediction sequence to obtain the final result of probabilistic prediction of medium and long-term wind power, wherein the smoothed error sequence and the corrected error sequence are as follows:
$${E}_{t}^{s} = ( α + {β}_{t} ) {E}_{t} + ( 1 - α - {β}_{t} ) {E}_{t - 1}^{s}$$
$${E}_{t}^{c} = LSTM ( {E}_{t}^{s} )$$
where
$${E}_{t}^{s}$$
denotes a smoothed error sequence, a denotes α smoothing coefficient within a range of [0,1], and
$${E}_{t}^{c}$$
denotes a corrected error sequence.

2. The method for probabilistic prediction of medium and long-term wind power based on time sequence attention according to claim 1, wherein the preprocessing process comprises:
each xᵢ in a data set D={x₁, x₂, . . . , xₙ} being a d-dimensional feature vector, filling missing values of the meteorological data and the wind power by using a dynamic adaptive K-nearest neighbor filling method, and calculating a local density of the current missing points by calculating a Mahalanobis distance between a missing point and the nearest Kₘₐₓ neighbors in a training set;
dynamically selecting a value of K according to the local density;
calculating a Gaussian weight wᵢₗ of the missing point and each neighboring point, and adding a time sequence regularization term; and
after normalizing the calculated Gaussian weight, calculating the missing values and filling the missing values in corresponding positions, performing a normalizing process on the meteorological data and the wind power data which are filled with the missing values, and dividing the data set into a training set and a test set.

3. The method for probabilistic prediction of medium and long-term wind power based on time sequence attention according to claim 1, wherein performing probabilistic prediction of medium and long-term wind power based on the fused feature comprises:
defining a loss function of a quantile and a quantile regression, wherein the loss function of the quantile regression is expressed as:
$${L}_{τ} ( y , \hat{y} ) = \{ \begin{matrix}τ \cdot ( y - \hat{y} ) & y \geq \hat{y} \\ ( 1 - τ ) \cdot ( \hat{y} - y ) & \hat{y} < y\end{matrix}$$
where τ denotes a target quantile, y denotes a true value, and ŷ denotes a predicted value;
constructing a quantile regression Long Short-Term Memory (LSTM) model, using the obtained data of fusing time sequence and dependency features as an input of the quantile regression LSTM model, and performing probabilistic prediction of future wind power, wherein a size of an output layer is equal to the number of quantiles; and
using the obtained predicted value of each quantile as a reference point of probability distribution, fitting normal probability distribution, and calculating a coverage probability to evaluate accuracy of a probability prediction interval, wherein the formula is as follows:
$$CP = \frac{1}{N} {\sum }_{i = 1}^{N} Π ( {y}_{i} ∈ [ L , U ] )$$
where CP denotes a coverage probability, N denotes a sample space, yᵢ denotes a true value of an i-th sample, Π(·) indicates that the value is 1 if a function condition holds, otherwise, the value is 0, L denotes a lower limit of a prediction interval, and U denotes an upper limit of the prediction interval.

4. A system for probabilistic prediction of medium and long-term wind power based on time sequence attention, which applies the method according to claim 3, wherein the system comprises:
a data acquisition and processing unit, which is configured to obtain and preprocess meteorological data and fan power related data of a wind farm;
a sequence feature extraction unit, which is configured to input the preprocessed data set into an encoder of a multi-attention dependency relationship calculation module and a time sequence feature extraction module, respectively, to obtain first feature data with local and long-term dependency and second feature data with time sequence information;
a feature fusion unit, which is configured to input the first feature data and the second feature data into a bidirectional cross-attention module, and fuse features extracted by different modules by calculating the attention weight;
a probabilistic prediction unit, which is configured to perform probabilistic prediction of medium and long-term wind power based on the fused feature to obtain a preliminary prediction result; and
a prediction result correction unit, which is configured to introduce an adaptive exponential smoothing error correction module to correct the preliminary prediction result to obtain a final result of probabilistic prediction of medium and long-term wind power.

5. An electronic device, comprising a memory and a processor, wherein the memory is configured to store computer-executable instructions, the processor is configured to execute the computer-executable instructions, and the computer-executable instructions, when executed by the processor, implement the steps of the method according to claim 3.

6. A computer-readable storage medium having computer-executable instructions stored thereon, wherein the computer-executable instructions, when executed by a processor, implement the steps of the method according to claim 3.
